(19) United States
(12) Patent Application Publication
(10) Pub. No.: US 2021/0331005 A1
(43) Pub. Date: Oct. 28, 2021

(54) Cough Catching Device

(71) Applicant: Margaret Farrier, Rochester, NY (US)

(72) Inventor: Margaret Farrier, Rochester, NY (US)

(21) Appl. No.: 17/239,539

(22) Filed: Apr. 23, 2021

Related U.S. Application Data
(60) Provisional application No. 63/014,343, filed on Apr. 23, 2020.

(51) Int. Cl. A62B 23/00; A62B 25/00

(52) U.S. Cl. CPC A62B 23/00; A62B 25/00

(57) ABSTRACT

A cough catching device is an apparatus used to limit the spread of airborne and droplet-transmissible pathogens by providing a sanitary tool to substantially capture a cough or sneeze. The cough catching device utilizes at least one membrane enclosing an internal cavity, wherein an aperture is formed into the membrane in fluid communication with the internal cavity. At least one flexible member is integrated into the membrane to bias the aperture closed over the internal cavity. The flexible member may be manually deformed by a user to expand the aperture, enabling a user to cough or sneeze into the internal cavity to capture any droplets with the membrane.

The current application claims a priority to the U.S. Provisional Patent application Ser. No. 63/014,343 filed on Apr. 23, 2020.

### FIELD OF THE INVENTION

The present invention generally relates to sanitary hygiene. More specifically, the present invention relates to a device for reducing the spread of germs from coughing or sneezing.

### BACKGROUND OF THE INVENTION

A device that prevents the spread of germs from coughing is in demand. The seasonal flu (influenza) is a respiratory virus whose symptoms include coughing. This, and certain other infections, spread from person to person when coughing or sneezing expels microscopic water droplets from an infected person. Many people cough or sneeze into their hands, which thus become covered with germs. As a result, infected people can transfer germs to other people by touching commonly used things with their hands.

This common disease vector can result in a devastating contagion spread in a relatively short period. To wit, many people are now suffering from the novel coronavirus (COVID-19). On Mar. 11, 2020, the World Health Organization declared the COVID-19 outbreak a pandemic. The Centers for Disease Control and Prevention (CDC) has reported the existence of several hundred thousand confirmed cases of the virus, which have caused deaths in approximately 150 countries. In April 2020, the United States recorded thousands of deaths linked to the disease. Globally, the death toll has exceeded 3 million according to Johns Hopkins University at time of writing. Further, the U.S. economy lost 701,000 jobs in March 2020, according to data released by the Bureau of Labor Statistics.

COVID-19 is a serious respiratory disease that can cause coughing, fever, and shortness of breath. Studies have shown that the coronavirus can also cause brain damage in patients. Doctors in the US as well as Italy and China have all reported neurological conditions in multiple coronavirus patients. Physicians are finding that some patients are experiencing damaged cells in areas of the brain that have led to stroke and loss of taste and smell. Thus, there are growing concerns that patients currently dealing with the coronavirus may eventually suffer long term effects of brain damage.

COVID-19 spreads primarily through airborne liquid droplets emitted from the nose and mouth when an infected person coughs, sneezes, or exhales. Germs can spread quickly between students at school as well as in other settings, such as in nursing homes and community gatherings and on public transportation, including buses, trains, and airplanes.

As a group, the elderly are especially susceptible to the disease. Infection experts recommend that people use their arms to catch sneezes and coughs, such as by using the crook of the arm, or inner elbow, to prevent the spread of germs. However, this method does not solve the problem of having one's clothing or arms covered with germs, including sputum (mucus, phlegm, and other such matter). Not only can this be unpleasant to people, but it also still allows transfer of germs to others who touch the person around the arm that is covered by germs. Accordingly, although use of the arms to catch germs may avoid coughing directly into the hands, pathogens may later be transferred to the hands or otherwise conveyed to others. Alternatively, people can use tissues to clean up the arms or cover the mouth and nose when coughing or sneezing, but tissues are not always readily available. Likewise, people can wear surgical masks to keep from spreading germs to others, but masks are not always disposable and can be easily lost. Further, carrying multiple changes of mask can be inconvenient and expensive. Thus, there is a need for a device that captures coughs with a view to minimizing the spread of germs and other antigens.

The present invention is intended to address problems associated with and/or otherwise improve on conventional devices through an innovative cough catching device that is designed to provide a convenient means of catching coughs and sneezes while incorporating other problem-solving features. Additional advantages of the invention will be set forth in part in the description which follows, and in part will be obvious from the description, or may be learned by practice of the invention. Additional advantages of the invention may be realized and attained by means of the instrumentalities and combinations particularly pointed out in the detailed description of the invention section. Further benefits and advantages of the embodiments of the invention will become apparent from consideration of the following detailed description given with reference to the accompanying drawings, which specify and show preferred embodiments of the present invention.

### BRIEF DESCRIPTION OF THE DRAWINGS

FIG. 1 is a top-front perspective view of one embodiment of the present invention, wherein at least one flexible member is shown in broken-line.

FIG. 2 is a sectional view of at least one membrane, wherein distinct layers are separated to show construction.

FIG. 3 is a top-front-right perspective view of the present invention.

FIG. 4 is right-side elevational view thereof, wherein the present invention is shown mounted to a user's arm in an exemplary application.

FIG. 5 is an alternate perspective view thereof, wherein the present invention is shown with a peripheral shroud deployed.

FIG. 6 is a top plan view of a holster assembly.

FIG. 7 is a bottom-left-rear perspective view thereof, wherein the holster assembly is illustrated inverted to shown construction.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced or utilized without the implementation of some features as they are described. It should be understood that some details have not been described in detail in order to not unnecessarily obscure focus of the invention. References herein to “the preferred embodiment”, “one embodiment”, “some embodiments”, or “alternative embodiments” should be considered to be illustrating aspects of the present invention that may potentially vary in some instances, and should not be considered to be limiting to the scope of the present invention as a whole.

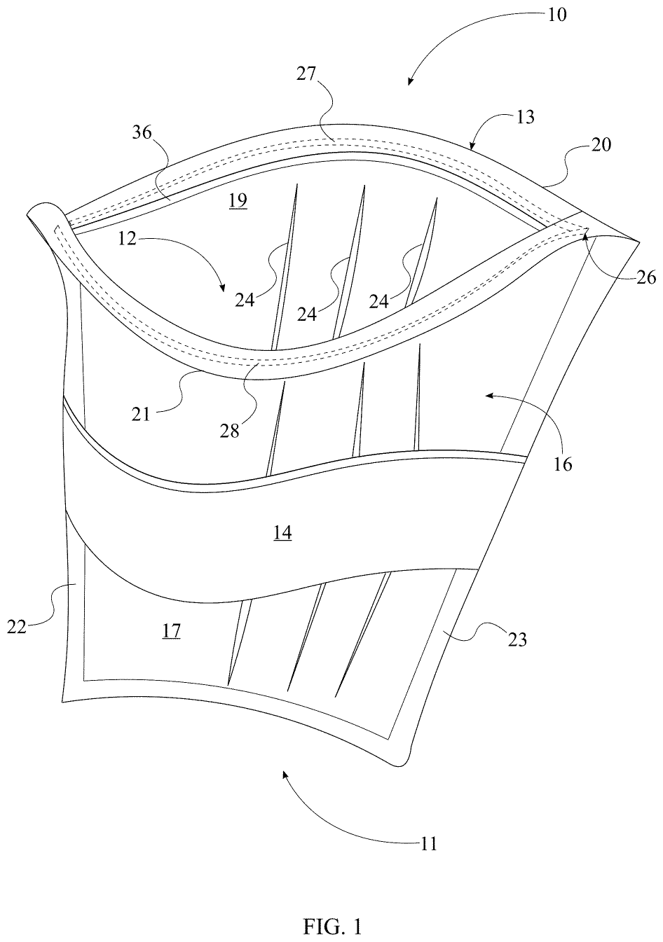

In reference to FIG. 1 through 7, the present invention is a cough catching device comprising at least one membrane 16, an internal cavity 12, and at least one flexible member 26. The membrane 16 constitutes a fabric, mesh, cloth, or other similar textile-like media that is suitable for use in sanitary applications and sterile environments. In the preferred embodiment, the membrane 16 is composed of a substantially biodegradable material, thereby enabling the present invention to be recycled or disposed of with a minimum of environmental impact. The internal cavity 12 defines a hollow area within the membrane 16. More specifically, the membrane 16 and the internal cavity 12 extend between an open end 10 and a seam end 11, preferably defining a hollow elongate body and an empty volume therein. The membrane 16 is peripherally self-connected between the open end 10 and the seam end 11. The self-attachment of the membrane 16 may be achieved with any known form of mechanical, chemical, or thermal attachments including glue stamping, ultrasonic bonding, sewing, thermal binding, perforated binding, or other processes as may be realized by a person of ordinary skill.

Further, an aperture 13 is formed into the open end 10 of the membrane 16 as shown in FIGS. 1, 3, and 4. The internal cavity 12 is positioned within the membrane 16, wherein the internal cavity 12 is in fluid communication with the aperture 13. In this arrangement the internal cavity 12 provides an area to receive any droplets (e.g., saliva, phlegm) resultant from a cough, ideally capturing these infection vectors to prevent the spread of any pathogens. The aperture 13 is configured to prevent the release of these pathogens from within the internal cavity 12, thereby trapping the droplets with the membrane 16. Accordingly, the at least one flexible member 26 is integrated into the open end 10 of the membrane 16, wherein the at least one flexible member 26 is configured to close the aperture 13 over the internal cavity 12. The at least one flexible member 26 defines a resilient strip of material configured to return to a relaxed state, even after significant deformation. This functionality enables the at least one flexible member 26 to be used as a soft mechanical lever to draw the aperture 13 open by compressing opposing ends of the flexible member 26, consequently opening the aperture 13. Upon release, the flexible member 26 will return to a relaxed position and draw the aperture 13 closed, sealing the membrane 16 over the internal cavity 12.

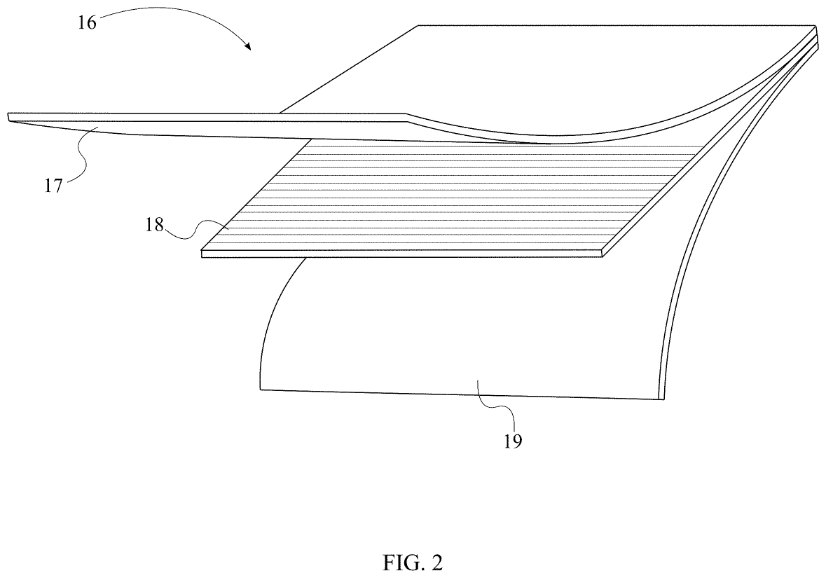

The membrane 16 is broadly contemplated to constitute any suitable textile-like material as may be suitable for use as a sanitary item. More specifically, the membrane 16 may constitute a lamination of multiple distinct material layers to provide optimal durability and antimicrobial qualities. Accordingly, the at least one membrane 16 further comprises an outer layer 17, a filter layer 18, and an inner layer 19 as shown in FIG. 2. The filter layer 18 is an antimicrobial element, ideally constituting a melt-blown fabric configured to trap or resist penetration of microbes identifiable as harmful, thereby ensuring that the membrane 16 is substantially impermeable to any pathogens trapped within the internal cavity 12. The outer layer 17 is superimposed onto the filter layer 18 and the inner layer 19 is superimposed onto the filter layer 18, opposite the outer layer 17. The internal cavity 12 is positioned adjacent to the inner layer 19, opposite the filter layer 18. The distinct material compositions of the outer layer 17, filter layer 18, and inner layer 19 enable the use of compatibilized, but differing materials to achieve a hybridized embodiment of the membrane 16 that is functionally superior to a single contiguous material. For example, the outer layer 17 may be composed of a substantially hydrophobic, non-porous material to prevent droplets and other contaminants from sticking to the exterior of the membrane 16. The inner layer 19 may feature a compressible, softened surface quality to provide a comfortable surface for direct contact to a user's face. Further, the separation of the filter layer 18 enables the formation or encapsulation of a filtration or antibacterial element that is functionally superior in this role to any material that is specialized for use in the contemplated roles of the inner layer 19 or the outer layer 17. The means of attaching the outer layer 17 and the inner layer 19 to the filter layer 18 are broadly considered to include any or all known means of lamination or assembly as may be realized by a reasonably skilled individual.

In at least one embodiment, the at least one flexible member 26 comprises a first member 27 and a second member 28 as shown in FIG. 1. The first member 27 and the second member 28 are preferably equal-length strands of resilient material, substantially similar in composition to the broader description of the at least one flexible member 26. The first member 27 is integrated into a first hem 20 of the membrane 16, adjacent to the aperture 13. The second member 28 is integrated into a second hem 21 of the membrane 16, opposite the first member 27 across the aperture 13. The first hem 20 and the second hem 21 preferably define stitched constructs similar to a conventional garment hem, wherein the first member 27 and the second member 28 are retained within the first hem 20 and the second hem 21 respectively. In at least one alternate embodiment, the first member 27 and the second member 28 may be chemically or thermally bonded into the membrane 16 at the first hem 20 and second hem 21 without departing from the original spirit and scope of the invention. The first member 27 and the second member 28 are oriented substantially parallel to each other in a relaxed state, wherein the aperture 13 is substantially occluded by the first hem 20 and the second hem 21 in the relaxed state. The relaxed state will prevent the escape of any pathogens or airborne contaminants from within the internal cavity 12 until a user manually opens the aperture 13 by deforming the first member 27 and the second member 28 away from each other. More specifically, a user may compress the adjacent ends of the first member 27 and the second member 28 together, deforming the first member 27 and the second member 28 into a pair of opposing arches and forcing the aperture 13 to expand accordingly.

It is further considered that the internal cavity 12 may force a limit on the volume of air that may be captured by the membrane 16 in any single cough. Any excess would necessarily spill out over a user's face and hands, defeating the sanitary purpose of the present invention. Therefore, at least one membrane 16 the further comprises a plurality of creases 24 formed into the membrane 16 between the open end 10 and the seam end 11 as shown in FIG. 1. The plurality of creases 24 is configured to serially overlap, wherein the volume of the internal cavity 12 is transformed by expanding or compressing the plurality of creases 24 relative to each other. This configuration enables the membrane 16, and the internal cavity 12 be extension, to expand during use. In the above-described scenario, any particularly voluminous cough would only billow out the plurality of creases 24 rather than spraying backwards out through the aperture 13. It is further considered that the plurality of creases 24 enables the efficient storage of multiple instances of the membrane 16 by allowing a user to collapse the present invention into a more compact form.

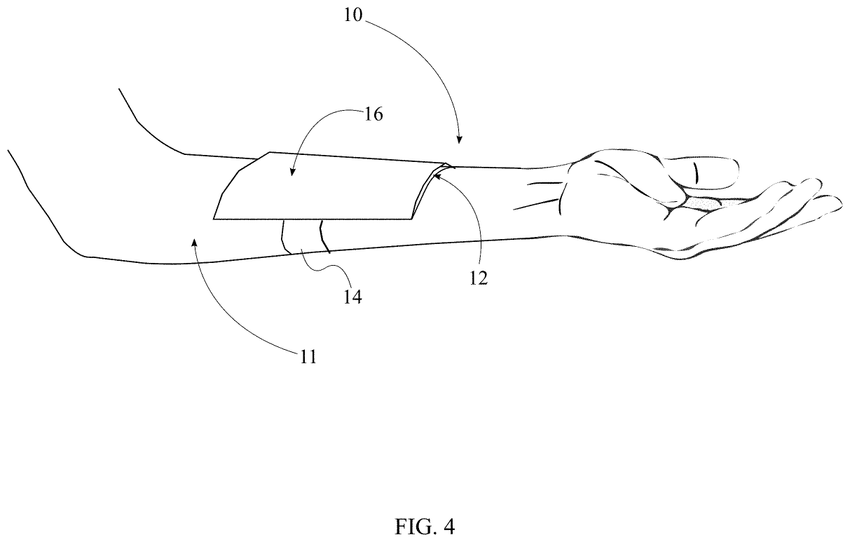

The present invention further comprises a retention band 14, wherein the retention band 14 is connected to at least one membrane 16. The retention band 14 preferably defines an elastic strap extending around a user's forearm as shown in FIG. 4. As coughing is often involuntary, the positioning of the membrane 16 onto a user's arm or wrist enables the present invention to be immediately accessible to a user as they reflexively reach to cover their mouth when coughing. This accessibility increases the likelihood that a user will have time to use the present invention in the preferred manner, i.e., by coughing through the aperture 13. Further, in emergencies or when caught unaware, the user may cough directly onto the membrane 16 to prevent their hands or arm from being contaminated by droplets of saliva.

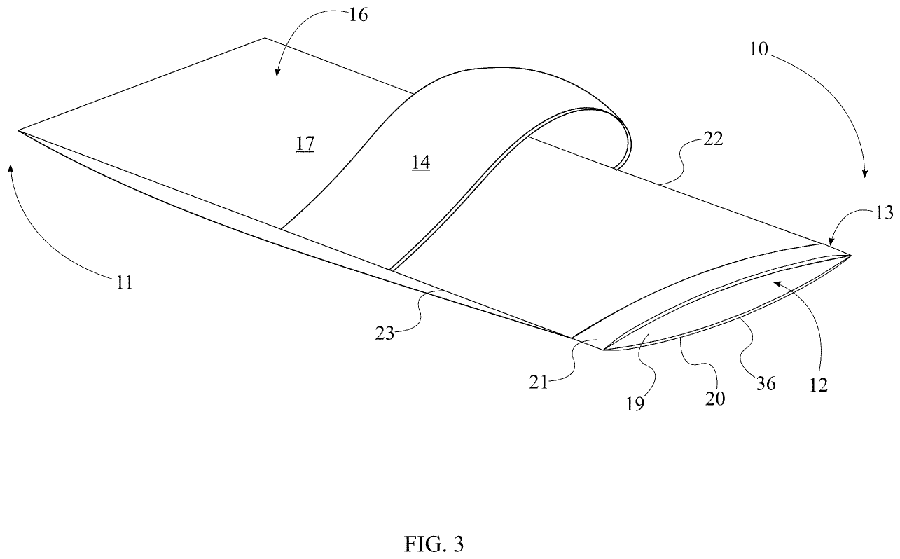

In reference to FIG. 3, the membrane 16 comprises a first edge 22 and a second edge 23, wherein the first edge 22 and the second edge 23 traverse between the open end 10 and the seam end 11. The retention band 14 is positioned between the open end 10 and the seam end 11, and the retention band 14 is terminally connected between the first edge 22 and the second edge 23. In this embodiment, the retention band 14 forms a continuous loop in combination with the membrane 16. The positioning of the retention band 14 across the membrane 16 in this fashion ideally positions the aperture 13 in proximity to the hand or wrist of a user. Further, the central positioning of the retention band 14 between the open end 10 and the seam end 11 ensures that the membrane 16 will lie relatively flat along a user's arm, minimizing the chances for the membrane 16 to become entangled with any other item or article while worn.

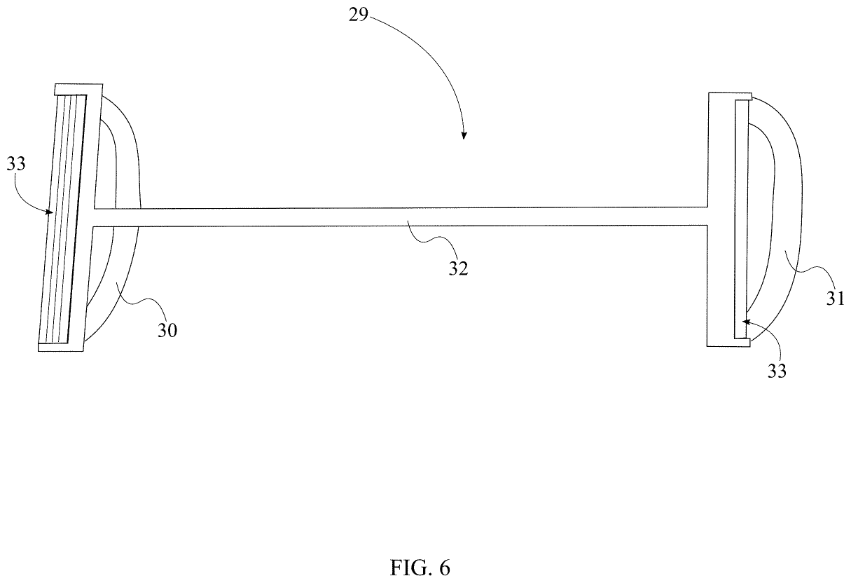

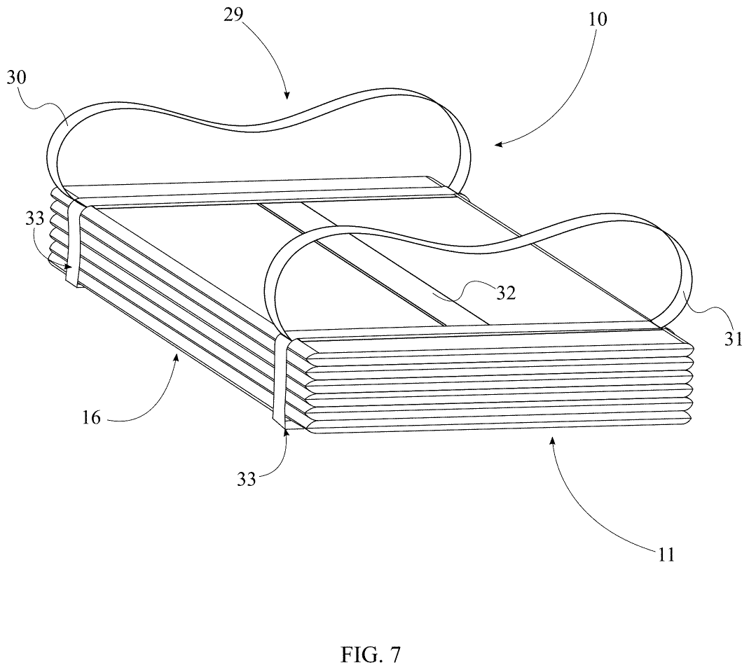

In keeping with known best practices regarding personal protective articles such as face masks, gloves, and the present invention; it is contemplated that a user may use and dispose of multiple instances of the present invention in relatively rapid succession. Accordingly, the present invention may further comprise a holster assembly 29 comprising a first band 30, a second band 31, and at least one connecting member 32 as shown in FIGS. 6 and 7. The first band 30 and the second band 31 constitute flexible, elastic, or otherwise adjustable webbing configured to receive a user's arm therethrough, similar to the retention band 14. The connecting member 32 constitutes a substantially rigid structure extending between the first band 30 and the second band 31, configured to receive multiple instances of the membrane 16 to enable extended use of the present invention by a user. More specifically, the first band 30 is terminally connected to the connecting member 32 and the second band 31 is terminally connected to the connecting member 32, opposite the first band 30. The membrane 16 is removably positioned adjacent to the connecting member 32 in a stored position, wherein the membrane 16 is retained to the connecting member 32 between the open end 10 and the seam end 11 in the stored position.

It is further considered that the connecting member 32 may provide a means of releasably retaining multiple instances of the membrane 16, thereby preventing any membrane 16 from being accidentally dislodged from the holster assembly 29. The connecting member 32 further comprises a plurality of retention structures 33, wherein the plurality of retention structures 33 is connected to the connecting member 32 between the first band 30 and the second band 31. Each of the plurality of retention structures 33 is broadly considered to include any suitable extension of the connecting member 32 that is congruent to or compatible with any portion of the membrane 16; including slots, tabs, hooks, clasps, straps, or any other form of releasable fastener.

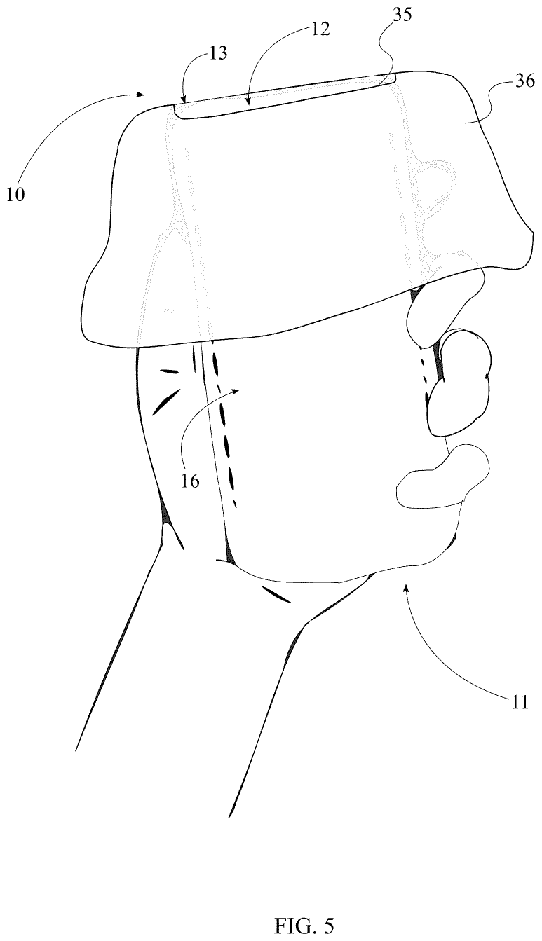

A primary function of the aperture 13 is to ensure that any contaminants expelled into the internal cavity 12 (saliva, phlegm, or droplets of any kind) do not spread to any surrounding surfaces. As shown in FIGS. 1 and 5, the present invention further comprises a terminal lip 35, wherein the terminal lip 35 is internally and perimetrically connected to the membrane 16 at the open end 10, adjacent to the aperture 13. The terminal lip 35 ideally constricts the aperture 13 to prevent even a slight parting of the aperture 13 from allowing any contaminants to escape. The terminal lip 35 preferably defines a compressible antimicrobial element similar to the composition of the filter layer 18, thereby ensuring that the aperture 13 remains sealed until a user manually expands the aperture 13 by deforming with the flexible member 26. Accordingly, the terminal lip 35 extends laterally inward from the membrane 16, wherein the geometry of the aperture 13 is defined by the terminal lip 35.

It is further considered that, in at least one embodiment, the present invention may provide a means of shielding a user's hand or arm from any scattered droplets that miss the aperture 13. Referring again to the involuntary nature of a cough or a sneeze, a user cannot be expected to have perfect timing and aim for every use. Accordingly, the present invention further comprises a peripheral shroud 36 connected to the terminal lip 35 as shown in FIG. 5. The peripheral shroud 36 ideally constitutes a n impermeable, non-porous material configured to prevent the transfer of contaminants therethrough. The peripheral shroud 36 extends through the aperture 13 and around the open end 10 of the membrane 16, consequently protecting any portion of the user's body (hand, wrist, arm, etc.) that is in the immediate vicinity of the aperture 13. It is specifically considered that the peripheral shroud 36 may be folded within the internal cavity 12 while not in use, thereby containing any captured contaminants with the membrane 16.

Although the invention has been explained in relation to its preferred embodiment, it is to be understood that many other possible modifications and variations can be made without departing from the spirit and scope of the invention as hereinafter claimed.

What is claimed is:

1. A cough catching device comprising:
at least one membrane;
an internal cavity;
at least one flexible member;
the membrane and the internal cavity extending between an open end and a seam end;
the membrane being peripherally self-connected between the open end and the seam end;
an aperture being formed into the open end of the membrane;
the internal cavity being positioned within the membrane, wherein the internal cavity is in fluid communication with the aperture; and
the at least one flexible member being integrated into the open end of the membrane, wherein the at least one flexible member is configured to close the aperture over the internal cavity.

2. The cough catching device as claimed in claim 1 comprising:
the at least one membrane comprising an outer layer, a filter layer, and an inner layer;
the filter layer being an antimicrobial element;
the outer layer being superimposed onto the filter layer;
the inner layer being superimposed onto the filter layer, opposite the outer layer; and
the internal cavity being positioned adjacent to the inner layer, opposite the filter layer.

3. The cough catching device as claimed in claim 1 comprising:
the at least one flexible member comprising a first member and a second member;
the first member being integrated into a first hem of the membrane, adjacent to the aperture;
the second member being integrated into a second hem of the membrane, opposite the first member across the aperture; and
the first member and the second member being oriented substantially parallel to each other in a relaxed state, wherein the aperture is substantially occluded by the first hem and the second hem in the relaxed state.

4. The cough catching device as claimed in claim 1 comprising:
the membrane further comprising a plurality of creases formed into the membrane between the open end and the seam end; and
the plurality of creases being configured to serially overlap, wherein the volume of the internal cavity is transformed by expanding or compressing the plurality of creases relative to each other.

5. The cough catching device as claimed in claim 1 comprising:
a retention band; and
the retention band being connected to the at least one membrane.

6. The cough catching device as claimed in claim 5 comprising:
the membrane further comprising a first edge and a second edge, wherein the first edge and the second edge traverse between the open end and the seam end;
the retention band being positioned between the open end and the seam end; and
the retention band being terminally connected between the first edge and the second edge, wherein the retention band forms a continuous loop in combination with the membrane.

7. The cough catching device as claimed in claim 1 comprising:
a holster assembly comprising a first band, a second band, and at least one connecting member;
the first band being terminally connected to the connecting member;
the second band being terminally connected to the connecting member, opposite the first band; and
the membrane being removably positioned adjacent to the connecting member in a stored position, wherein the membrane is retained to the connecting member between the open end and the seam end in the stored position.

8. The cough catching device as claimed in claim 7 comprising:
the connecting member further comprising a plurality of retention structures; and
the plurality of retention structures being connected to the connecting member between the first band and the second band.

9. The cough catching device as claimed in claim 1 comprising:
a terminal lip;
the terminal lip being internally and perimetrically connected to the membrane at the open end, adjacent to the aperture; and
the terminal lip extending laterally inward from the membrane, wherein the geometry of the aperture is defined by the terminal lip.

10. The cough catching device as claimed in claim 9 comprising:
a peripheral shroud;
the peripheral shroud being connected to the terminal lip; and
the peripheral shroud extending through the aperture and around the open end of the membrane.

11. The cough catching device comprising:
at least one membrane;
an internal cavity;
at least one flexible member;
the membrane and the internal cavity extending between an open end and a seam end;
the membrane being peripherally self-connected between the open end and the seam end;
an aperture being formed into the open end of the membrane;
the internal cavity being positioned within the membrane, wherein the internal cavity is in fluid communication with the aperture;
the at least one flexible member being integrated into the open end of the membrane, wherein the at least one flexible member is configured to close the aperture over the internal cavity;
the at least one membrane comprising an outer layer, a filter layer, and an inner layer;
the filter layer being an antimicrobial element;
the outer layer being superimposed onto the filter layer;
the inner layer being superimposed onto the filter layer, opposite the outer layer; and
the internal cavity being positioned adjacent to the inner layer, opposite the filter layer.

12. The cough catching device as claimed in claim 11 comprising:
the at least one flexible member comprising a first member and a second member;
the first member being integrated into a first hem of the membrane, adjacent to the aperture;
the second member being integrated into a second hem of the membrane, opposite the first member across the aperture; and
the first member and the second member being oriented substantially parallel to each other in a relaxed state, wherein the aperture is substantially occluded by the first hem and the second hem in the relaxed state.

13. The cough catching device as claimed in claim 11 comprising:
the membrane further comprising a plurality of creases formed into the membrane between the open end and the seam end; and
the plurality of creases being configured to serially overlap, wherein the volume of the internal cavity is transformed by expanding or compressing the plurality of creases relative to each other.

14. The cough catching device as claimed in claim 11 comprising:
a retention band; and
the retention band being connected to the at least one membrane.

15. The cough catching device as claimed in claim 14 comprising:
the membrane further comprising a first edge and a second edge, wherein the first edge and the second edge traverse between the open end and the seam end;
the retention band being positioned between the open end and the seam end; and
the retention band being terminally connected between the first edge and the second edge, wherein the retention band forms a continuous loop in combination with the membrane.

16. The cough catching device as claimed in claim 11 comprising:
a holster assembly comprising a first band, a second band, and at least one connecting member;
the first band being terminally connected to the connecting member;
the second band being terminally connected to the connecting member, opposite the first band; and
the membrane being removably positioned adjacent to the connecting member in a stored position, wherein the membrane is retained to the connecting member between the open end and the seam end in the stored position.

17. The cough catching device as claimed in claim 16 comprising:
the connecting member further comprising a plurality of retention structures; and
the plurality of retention structures being connected to the connecting member between the first band and the second band.

18. The cough catching device as claimed in claim 11 comprising:
a terminal lip;
the terminal lip being internally and perimetrically connected to the membrane at the open end, adjacent to the aperture; and
the terminal lip extending laterally inward from the membrane, wherein the geometry of the aperture is defined by the terminal lip.

19. The cough catching device as claimed in claim 18 comprising:
a peripheral shroud;
the peripheral shroud being connected to the terminal lip; and
the peripheral shroud extending through the aperture and around the open end of the membrane.
